(19) United States
(12) Patent Application Publication
(10) Pub. No.: US 2026/0247060 A1
(43) Pub. Date: Aug. 20, 2026

(54) Sound Output Apparatus

(71) Applicant: HUAWEI TECHNOLOGIES CO., LTD., Shenzhen (CN)

(72) Inventors: Chengrong Ma, Shenzhen (CN); Liang Li, Dongguan (CN); Jun Liu, Dongguan (CN); Le Liao, Dongguan (CN)

(73) Assignee: HUAWEI TECHNOLOGIES CO., LTD., Shenzhen (CN)

(21) Appl. No.: 19/647,455

(22) Filed: Apr. 14, 2026

Related U.S. Application Data
(63) Continuation of application No. PCT/CN2025/087652, filed on Apr. 8, 2025.

(30) Foreign Application Priority Data
Jun. 25, 2024 (CN) 202421478721.9

(51) Int. Cl. H04R 1/10; H04R 1/24

(52) U.S. Cl. CPC H04R 1/1075; H04R 1/1016; H04R 1/24; H04R 2400/11

(57) ABSTRACT

A sound output apparatus includes a housing, a first bracket, a microphone, and a first speaker. The housing is provided with an accommodation space. The first bracket is fastened within the accommodation space of the housing. The first bracket includes a first surface and a second surface that face away from each other. The microphone is fastened to the first surface. The first speaker is fastened to the second surface. The microphone, the first bracket, and the first speaker are stacked in a first direction. The first bracket is used for separate fastening of the microphone and the first speaker.

### CROSS-REFERENCE TO RELATED APPLICATIONS

This application is a continuation of International Patent Application No. PCT/CN2025/087652, filed on Apr. 8, 2025, which claims priority to Chinese Patent Application No. 202421478721.9, filed on Jun. 25, 2024. The disclosures of the aforementioned applications are hereby incorporated by reference in their entireties.

### TECHNICAL FIELD

This disclosure relates to the field of audio device technologies, and in particular, to a sound output apparatus.

### BACKGROUND

With development of true wireless stereo (TWS) earphones, users have gradually higher requirements for noise reduction effect and sound quality of the earphones.

An existing noise reduction earphone has a large quantity of internal components, and is limited by an internal space size of the earphone, making it difficult to balance noise reduction effect and sound quality of the earphone. In some technologies, there is a solution in which a plurality of sound-emitting units are disposed to improve sound quality, but this complicates an assembly and connection manner of an earphone, making it difficult to ensure reliability and consistency.

### SUMMARY

An objective of embodiments of this disclosure is to provide a sound output apparatus.

According to a first aspect, this disclosure provides a sound output apparatus, including a housing, a first bracket, a microphone, and a first speaker. The housing is provided with an accommodation space. The first bracket is fastened to the accommodation space of the housing. The first bracket includes a first surface and a second surface that face away from each other. The microphone is fastened to the first surface. The first speaker is fastened to the second surface.

The second surface faces away from the first surface. In other words, an included angle between a positive direction of a normal of the first surface (for a surface of an entity, a positive direction of a normal is a direction from the inside of the entity to the outside of the entity) and a positive direction of a normal of the second surface is greater than 90°.

The microphone and the first speaker are located on different surfaces of the first bracket, and the microphone and the first speaker are fastened to the first bracket. The first bracket is used for separate fastening of the microphone and the first speaker, so that the first bracket has little impact on a size of an audio assembly in a first direction. This helps reduce the size of the audio assembly in the first direction, to improve compactness of a structure of the audio assembly. In addition, the microphone and the first speaker are located on different sides of the first bracket, so that mounting of the microphone and mounting of the first speaker do not affect each other. This facilitates assembly of the microphone and the first speaker. Moreover, the microphone, the first bracket, the first speaker, and the like may be first assembled to form an independent module (the audio assembly), there is substantially no need to consider impact of another component (for example, the housing) of the sound output apparatus (an earphone) on the microphone, the first bracket, and the first speaker during assembly, and a space during assembly is large. This helps improve accuracy and consistency in mounting the module (the audio assembly) in the housing.

In this embodiment, because the microphone, the first bracket, the first speaker, and the like may be first assembled to form the independent module (the audio assembly), when the module is assembled into the housing, there is substantially no need to consider impact of another component (for example, the housing) of the sound output apparatus (the earphone) on the microphone, the first bracket, and the first speaker. This helps improve accuracy and consistency in mounting the module (the audio assembly) in the housing.

In some implementations, the first bracket is provided with a first mounting groove, the first surface is at least partially formed on a bottom surface of the first mounting groove, and at least a part of a structure of the microphone is located in the first mounting groove.

The first bracket is provided with a second mounting groove, the second surface is at least partially formed on a bottom surface of the second mounting groove, and at least a part of a structure of the first speaker is located in the second mounting groove.

A size of the first mounting groove may be set to correspond to a size of the microphone. A size of the second mounting groove may be set to correspond to a size of the first speaker.

In the implementations, the first mounting groove is provided, so that the first mounting groove can be used for positioning of the microphone, and also used for mounting of the microphone. The microphone is generally small, and the first mounting groove is equivalent to surrounding at least the part of the structure of the microphone, so that a groove structure of the first mounting groove can have more contact surfaces and a larger contact area with the microphone. In this way, the microphone is more reliably fastened. The second mounting groove is provided, so that the second mounting groove can be used for positioning of the first speaker, and also used for fixed mounting of the first speaker.

In some implementations, the first bracket is provided with a positioning groove, the first speaker includes a positioning portion, the positioning portion protrudes, and the positioning portion is located in the positioning groove and is fastened to a groove wall of the positioning groove of the first bracket.

In the implementations, the positioning groove is used for positioning of the first speaker in the first bracket, and is further configured to connect the first speaker to the first bracket. The positioning portion of the first speaker is mounted in the positioning groove, the positioning portion is a partial structure of the first speaker, and volumes of both the positioning portion and the positioning groove may be set to be small, to facilitate selection of a proper position on the first bracket for providing of the positioning groove, and facilitate selection of a proper position on the first speaker for formation of the positioning portion, so as to further simplify a structure design of the first bracket and the first speaker.

In some implementations, the first bracket is of a cover structure, the first bracket includes a top portion and a side portion, the side portion surrounds the top portion, the first surface is formed on a side of the top portion, the second surface is formed on another side of the top portion, the first surface is parallel to the second surface, and the side portion extends facing away from the first surface.

For example, the first surface may be a flat surface, and the second surface may be a flat surface.

In the implementations, the first surface is formed on a side of the top portion, the second surface is formed on another side of the top portion, and the first surface is parallel to the second surface. In this case, the microphone and the first speaker are connected to surfaces on the two sides of the top portion respectively, and there is substantially no spacing between the microphone, the top portion, and the first speaker in the first direction, so that the audio assembly has high compactness and a small size in the first direction.

In some implementations, the first bracket includes a main portion and a fastened portion, the fastened portion is located between the first speaker and the microphone, the first surface is formed on a surface on a side of the fastened portion, the second surface is formed on a surface on another side of the fastened portion, and the fastened portion is embedded in the main portion. A material of the main portion is plastic, and the fastened portion is a metal sheet.

In some implementations, the fastened portion is made of a metal material, so that the fastened portion can have high strength and a small thickness, to facilitate a thinning design of the audio assembly. The main portion is made of a plastic material. This helps reduce a weight of the main portion, to reduce a weight of the first bracket. In addition, this facilitates formation of the main portion, and can reduce manufacturing costs of the main portion.

In some implementations, the housing is provided with a sound outlet opening, the first bracket and the housing enclose a sound outlet channel, the sound outlet opening connects the sound outlet channel to the outside of the housing, and the first speaker outputs a sound through the sound outlet channel. The microphone is located on a side that is of the first bracket and that faces the sound outlet opening, and the microphone is located in the sound outlet channel.

In some implementations, the sound outlet channel is enclosed by the first bracket and the housing, the microphone is located in the sound outlet channel, the microphone is close to the sound outlet opening, and a sound at the sound outlet opening is directly transmitted to a human ear, so that a sound picked up by the microphone is closer to a sound actually heard by the human ear. This facilitates noise reduction of the sound output apparatus (the earphone). In addition, the microphone is fastened to the first bracket. In other words, there is no need to fasten the microphone to the housing at the sound outlet opening, so that the sound outlet channel at the sound outlet opening is not blocked. This helps the sound outlet channel have a larger sound outlet area, to improve sound outlet effect.

In some implementations, the first surface faces the sound outlet opening, the first bracket is provided with a first through hole, the first speaker is provided with a sound-emitting opening, and the first through hole connects the sound-emitting opening to the sound outlet channel.

When the first speaker is bonded to the first bracket, an adhesive may avoid the first through hole, so that the first through hole communicates with the sound-emitting opening and sealing at a connection is kept. The adhesive has a function of bonding the first speaker to the first bracket, and also has a sealing function.

In some implementations, the microphone can face the sound outlet opening, a sound emitted by the sound output apparatus (the earphone) can be picked up by the microphone, and a sound at the sound outlet opening can be directly propagated to the microphone, so that a propagation path is simpler. This facilitates sound pickup by the microphone. In addition, because the first through hole connects the sound-emitting opening to the sound outlet channel, a path between the sound-emitting opening of the first speaker and the sound outlet opening is substantially a straight line. In other words, the sound outlet channel used by the first speaker to output a sound through the sound outlet opening has a simple structure, and has little impact on the sound. This helps improve sound quality of the sound output apparatus (the earphone), and a simple sound outlet path helps simplify a structure of the sound output apparatus (the earphone).

In some implementations, the first bracket includes a fastened surface, the fastened surface is fastened to the housing, the fastened surface is a flat surface, and the fastened surface is perpendicular to a central line of the sound outlet opening.

In some implementations, the fastened surface being a flat surface facilitates formation of the fastened surface, to simplify manufacturing of the first bracket. The fastened surface is in contact with a mounting surface of the housing. This helps increase a bonding area, to improve fastening reliability. Because the fastened surface is connected to the housing, and a direction of force applied to the fastened surface is parallel to the first direction, during assembly of the audio assembly, the fastened surface may be mounted in the first direction, which is the same as a direction in which components in the audio assembly are assembled. This reduces assembly directions, and helps simplify an assembly process.

In some implementations, the sound output apparatus further includes a second speaker, the second speaker is fastened to the first bracket, and the first bracket, the first speaker, and the second speaker are sequentially stacked.

In some implementations, the first speaker may be configured to play a treble sound, and the second speaker may be configured to play mid and bass sounds. Sounds of different frequencies are played by the first speaker and the second speaker respectively. This facilitates utilization of respective characteristics of the first speaker and the second speaker, to help improve sound quality of the audio assembly. In addition, the second speaker is also stacked in the first direction, which is the same as a direction in which the microphone, the first bracket, and the first speaker are arranged. This facilitates mounting of the second speaker on the first bracket.

In some implementations, the first bracket is of a cover structure, the second speaker is mounted on an end portion of the first bracket, the first bracket and the second speaker enclose a mounting space, and the first speaker is located in the mounting space.

A cross section of the second speaker may be larger than a cross section of the first speaker, and a size of an end surface of the second speaker may be close to a size of the end portion that is of the first bracket and that is aligned with and connected to the second speaker. The end surface of the second speaker closes a cover space of the first bracket, to form the mounting space, and the first speaker is located in the mounting space.

In some implementations, the first speaker and the second speaker are fastened to the first bracket, and the first speaker is surrounded by the first bracket and the second speaker. In this way, structures of the first bracket, the first speaker, and the second speaker can be more compact, and space utilization is higher, to help improve miniaturization of the audio assembly. In addition, this facilitates fastening of the first speaker and the second speaker to the first bracket.

In some implementations, the first bracket includes a positioning pillar and a fastening pillar, an end portion that is of the second speaker and that faces the first bracket is provided with a positioning hole and a fastening hole, the positioning pillar is in a clearance fit with the positioning hole, the fastening pillar is located in the fastening hole, and the fastening pillar is bonded to the fastening hole by using an adhesive.

A shape of the positioning pillar may match a shape of the positioning hole. For example, the positioning pillar may be of a cylindrical pillar structure, the positioning hole may be of a cylindrical hole structure, and a diameter of the positioning pillar may be less than or equal to a diameter of the positioning hole. A size of the fastening pillar may be less than a size of the fastening hole, and there may be a spacing between an outer wall of the fastening pillar and an inner wall of the fastening hole.

In some implementations, the positioning hole and the positioning pillar are disposed, to facilitate positioning of the second speaker on the first bracket during mounting of the second speaker. The fastening hole and the fastening pillar are disposed, and are bonded by using the adhesive, so that connection between the second speaker and the first bracket is simpler and reliable.

In some implementations, the housing is provided with a sound outlet opening, the first bracket and the housing enclose a sound outlet channel, and the sound outlet opening connects the sound outlet channel to the outside of the housing. The first bracket is provided with a second through hole, the first speaker is spaced from the second speaker, a space between the first speaker and the second speaker forms a rear cavity of the first speaker and forms a front cavity of the second speaker, and the second through hole connects the front cavity of the second speaker to the sound outlet channel.

In some implementations, the front cavity of the second speaker communicates with the second through hole, the second speaker is equivalent to outputting a sound through the second through hole, and the sound of the second speaker is propagated to the second through hole from the front cavity, enters the sound outlet channel from the second through hole, and is propagated to the outside of the housing. The second through hole is provided on the first bracket, and it is easy to set an area of the second through hole to be large, so that the second speaker has a large sound outlet area. In addition, both the sound of the first speaker and the second speaker are fastened to the first bracket, and sounds of both the first speaker and the second speaker enter the sound outlet channel through the first bracket. This helps simplify a design of sound channels of the first speaker and the second speaker in the sound output apparatus (the earphone).

In some implementations, the second speaker includes a first sub-speaker and a second sub-speaker, the first sub-speaker is fastened to the second sub-speaker, and each of the first sub-speaker and the second sub-speaker is capable of emitting a sound.

For example, the first sub-speaker is mainly configured to emit a mid-frequency sound, and the second sub-speaker is mainly configured to emit a low-frequency sound.

In some implementations, both the first speaker and the second speaker can emit sounds, which helps improve sound quality of the sound output apparatus (the earphone). The first sub-speaker and the second sub-speaker are integrated to form the second speaker, which can improve a degree of integration of the first sub-speaker and the second sub-speaker and reduce an occupied space. The first speaker and the second speaker can also be assembled together into the sound output apparatus (the earphone), which improves assembly efficiency.

In some implementations, the sound output apparatus further includes a flexible circuit board, the flexible circuit board and the microphone are an integrally formed mechanical part, and the flexible circuit board is electrically connected to the first speaker and the second speaker.

In some implementations, because the flexible circuit board and the microphone are an integrally formed mechanical part, when the microphone is fastened to the first bracket, a step of electrically connecting the flexible circuit board to the first speaker and the second speaker may be synchronously performed, to simplify a step of assembling the audio assembly.

In some implementations, the flexible circuit board is located outside the microphone, the first bracket, and the second speaker, the first speaker includes a first wiring portion, the first bracket is provided with a third through hole, the first wiring portion passes through the third through hole, and the first wiring portion is electrically connected to the flexible circuit board.

In some implementations, manners of electrically connecting the flexible circuit board to the microphone, the first speaker, and the second speaker are simple, the flexible circuit board may cover the outside of the microphone, the first bracket, the first speaker, and the second speaker, and no additional arrangement is required for the flexible circuit board. In this way, mounting of the flexible circuit board is simple and convenient.

In some implementations, the sound output apparatus further includes a second bracket and a battery, the second bracket is fastened to the battery, the second bracket and the battery are located in the accommodation space, and the second bracket is fastened to the housing. The first bracket, the second bracket, and the battery are arranged in a first direction, the second bracket is located on a side that is of the first bracket and that faces away from the microphone, and the first direction is a direction in which the microphone, the first bracket, and the first speaker are arranged.

In some implementations, the second bracket and the battery may be assembled into the accommodation space of the housing in the first direction. This facilitates consistency with a direction in which the audio assembly is assembled, reduces assembly complexity, and simplifies a step of assembling the sound output apparatus (the earphone), to improve efficiency and quality in assembling the sound output apparatus (the earphone).

### BRIEF DESCRIPTION OF DRAWINGS

To describe technical solutions in embodiments of this disclosure or in the background, the following describes accompanying drawings used in embodiments of this disclosure or the background.

FIG. 1 is a diagram of a structure of an earphone according to an embodiment;

FIG. 2 is a diagram of a structure of the earphone shown in FIG. 1 from another viewpoint;

FIG. 3 is a diagram of an exploded structure of the earphone shown in FIG. 1;

FIG. 4 is a diagram of an exploded structure of a housing shown in FIG. 1;

FIG. 5 is a sectional view of a housing shown in FIG. 1;

FIG. 6 is a diagram of an exploded structure of an audio assembly shown in FIG. 3;

FIG. 7 is a diagram of a structure of a first bracket shown in FIG. 6;

FIG. 8 is a diagram of a structure of the first bracket shown in FIG. 7 from another viewpoint;

FIG. 9 is a diagram of an exploded structure of the first bracket shown in FIG. 7;

FIG. 10 is a diagram of a structure of a first speaker shown in FIG. 6;

FIG. 11 is a sectional view of a partial structure of an audio assembly shown in FIG. 3;

FIG. 12 is a diagram of a structure of a second speaker shown in FIG. 6;

FIG. 13 is a sectional view of a partial structure of an audio assembly shown in FIG. 3;

FIG. 14 is a sectional view of a partial structure of an audio assembly shown in FIG. 3;

FIG. 15 is a diagram of structures of a flexible circuit board and a microphone shown in FIG. 6;

FIG. 16 is a sectional view of a partial structure of an audio assembly shown in FIG. 3;

FIG. 17 is a sectional view of a partial structure of the earphone shown in FIG. 1;

FIG. 18 is a sectional view of a partial structure of the earphone shown in FIG. 1;

FIG. 19 is a sectional view of the earphone shown in FIG. 1;

FIG. 20 is a sectional view of the earphone shown in FIG. 1 from another viewpoint; and

FIG. 21 is a diagram of an exploded structure of a partial structure of an audio assembly shown in FIG. 3.

### DESCRIPTION OF EMBODIMENTS

The following describes embodiments of this disclosure with reference to accompanying drawings in embodiments of this disclosure.

In the descriptions of embodiments of this disclosure, it should be noted that the terms “mounting” and “connection” should be understood in a broad sense unless there is a clear stipulation and limitation. For example, “connection” may be detachable connection, nondetachable connection, direct connection, or indirect connection through an intermediate medium. “A plurality of” means at least two.

Orientation terms mentioned in embodiments of this disclosure, for example, “upper”, “lower”, “inner”, “outer”, “top”, “bottom”, and “side” are merely directions based on the accompanying drawings. Therefore, the orientation terms are used to better and more clearly describe and understand embodiments of this disclosure, instead of indicating or implying that a specified apparatus or element should have a specific orientation, and be constructed and operated in the specific orientation. Therefore, the orientation terms cannot be understood as a limitation on embodiments of this disclosure.

In embodiments of this disclosure, a limitation on a relative position relationship is mentioned, for example, parallel, perpendicular, or aligned. These limitations are all defined based on a current technique level, but are not absolutely strict limitations. A small deviation is allowed, and being approximately parallel, approximately perpendicular, approximately aligned, or the like is allowed. For example, that A is parallel to B means that A is parallel or approximately parallel to B, and an included angle of 0 degrees to 10 degrees between A and B is allowed. For example, that A is perpendicular to B means that A is perpendicular or approximately perpendicular to B, and an included angle of 80 degrees to 100 degrees between A and B is allowed.

In embodiments of this disclosure, the terms “first”, “second”, “third”, and “fourth” are merely intended for a purpose of description, and shall not be understood as an indication or implication of relative importance or an implicit indication of a quantity of indicated technical features. Therefore, a feature defined by “first”, “second”, “third”, or “fourth” may explicitly or implicitly include one or more features.

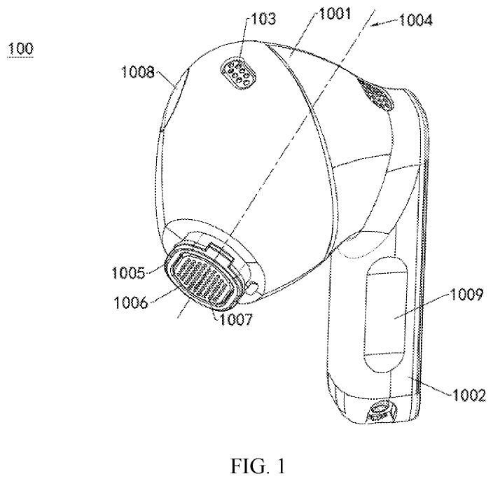

A sound output apparatus provided in embodiments of this disclosure is used for sound output, for example, music playing, voice information playing, or a call. The sound output apparatus may be a device such as an earphone or a player. A sound output apparatus 100 in an embodiment shown in FIG. 1 is described by using an earphone as an example. In the following descriptions, the reference numeral of the sound output apparatus 100 is used as a reference numeral of the earphone.

FIG. 1 is a diagram of a structure of an earphone 100 according to an embodiment of this disclosure.

In some embodiments, the earphone 100 may be a wireless earphone, or may be a wired earphone. When the earphone 100 is a wireless earphone, the earphone 100 may be communicatively connected to another electronic device. The another electronic device may be a device having a communication function, such as an earphone 100, a mobile phone, a watch, a tablet computer (tablet personal computer), a notebook computer, a vehicle-mounted device, a wearable device, augmented reality (AR) glasses, an AR helmet, virtual reality (VR) glasses, or a VR helmet. The earphone 100 in the embodiment shown in FIG. 1 is a wireless earphone, for example, a Bluetooth earphone. In an embodiment, the earphone 100 is a TWS earphone. It should be noted that FIG. 1 merely schematically shows one earphone 100 (in other words, the earphone 100 includes at least one earbud). In another implementation, the earphone 100 may alternatively include two or more earbuds, where the two earbuds provide sounds for a left ear and a right ear respectively.

In addition, the earphone 100 may be a half-in-ear earphone, an in-ear earphone, or an over-ear headphone.

For ease of description below, it is defined as follows: The earphone 100 has relative orientations “top” and “bottom”, which correspond to a height direction of the earphone 100; the earphone 100 has relative orientations “left” and “right”, which correspond to a width direction of the earphone 100; and the earphone 100 has relative orientations “front” and “rear”, which correspond to a thickness direction of the earphone 100. In descriptions of some embodiments, the orientation “upper” corresponds to the orientation “top”, and the orientation “lower” corresponds to the orientation “bottom”.

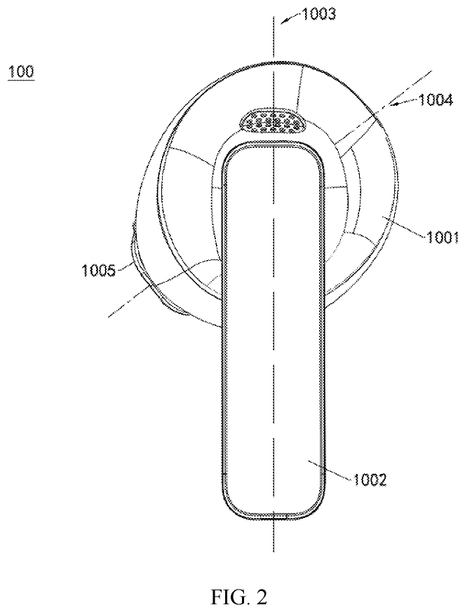

Refer to FIG. 1 and FIG. 2. FIG. 2 is a diagram of a structure of the earphone 100 shown in FIG. 1 from another viewpoint.

In some embodiments, the earphone 100 includes an ear cup 1001 and a stem 1002, and a top portion of the stem 1002 is connected to a rear side of the ear cup 1001. An outer surface of the earphone 100 is a geometric curved surface that implements a smooth transition. The stem 1002 may also be referred to as a handle. The stem 1002 is configured to be held by a user to operate the earphone 100. The stem 1002 is approximately of a straight rod structure. When the earphone 100 is an in-ear earphone, the ear cup 1001 may be inserted in an ear of the user, to fit the earphone 100 securely.

For example, the earphone 100 may have a central plane 1003, and a central axis 1004 of the ear cup 1001 may be inclined relative to the central plane 1003. When the earphone 100 is used as a left earphone, a bottom end of the central axis 1004 of the ear cup 1001 may be deflected leftward relative to the central plane 1003, and a top end of the central axis 1004 of the ear cup 1001 may be deflected rightward relative to the central plane 1003. When the earphone 100 is used as a right earphone, a bottom end of the central axis 1004 of the ear cup 1001 may be deflected rightward relative to the central plane 1003, and a top end of the central axis 1004 of the ear cup 1001 may be deflected leftward relative to the central plane 1003. For example, an outer contour of the stem 1002 may be symmetrically arranged relative to the central plane 1003.

For example, the earphone 100 may include a sound outlet portion 1005, and the sound outlet portion 1005 may be formed on the ear cup 1001. A sound outlet opening 1006 may be formed on the sound outlet portion 1005, and the sound outlet opening 1006 is configured to output a sound. The central axis 1004 of the ear cup 1001 may run through the sound outlet portion 1005, and the central axis 1004 may coincide with a central line of the sound outlet opening 1006. For example, a plurality of sound outlet holes 1007 are provided at the sound outlet opening 1006, and a sound emitted from the inside of the earphone 100 may be emitted through the sound outlet holes 1007 and propagated to the outside. The plurality of sound outlet holes 1007 may be arranged in an array, but this is not strictly limited thereto.

In some embodiments, the earphone 100 may further include a wearing detection module 1008. The wearing detection module 1008 may be mounted on the ear cup 1001 and exposed from the ear cup 1001.

For example, in some use scenarios, the earphone 100 may determine, by using a wearing detection function, whether the user wears/takes off the earphone 100, to automatically play/pause music. In some other use scenarios, if the user takes off the earphone 100, does not wear the earphone for a long time, and does not put the earphone back into a charging case, the earphone 100 automatically sleeps/shuts down, to save power. In some other use scenarios, to improve experience of single/dual-ear use of the earphone 100, when two earphones 100 are worn, both the two earphones 100 play music, and when one earphone 100 is taken off and the other earphone 100 is worn, the earphone 100 in a non-worn state stops playing music, and the earphone 100 in a worn state continues to play music, to implement seamless switching.

In some embodiments, the earphone 100 may include an operation region 1009. The operation region 1009 may be located on the stem 1002. The user may operate the earphone 100 by touching the operation region 1009.

For example, in some use scenarios, the earphone 100 may detect different touch actions or operation actions performed by the user on the operation region 1009, to implement functions such as music playing/pausing, track switching, volume adjustment, and intelligent voice wakeup of the earphone 100. This allows the earphone 100 to be used to some extent independently of a terminal (a mobile phone, a tablet, or the like) connected to the earphone, making an operation more convenient and faster, thereby helping improve user experience.

In some other embodiments, the earphone 100 may further include a circuit assembly (not shown in the figure), and the circuit assembly may be located in the stem 1002. For example, the circuit assembly may include a circuit board. A plurality of components may be fastened on each circuit board. For example, a main control chip may be arranged on a main circuit board, and the main control chip may be a system on chip (SoC). A plurality of circuits may be integrated into the main control chip. The circuit assembly is electrically connected to another functional component, module, and the like of the earphone 100. For example, the circuit assembly may be electrically connected to an audio assembly in the following, to control a working status of the audio assembly.

In some other embodiments, the earphone 100 may further include an antenna (not shown in the figure). The antenna may be located in the stem 1002. For example, the antenna is configured to implement wireless communication between the earphone 100 and another terminal (for example, a mobile phone or a tablet).

In some other embodiments of this disclosure, the earphone 100 may include more or fewer components than those in the foregoing embodiment, some components may be combined, some components may be split, or different component arrangements may be used. Components of the earphone 100 may be implemented by hardware, software, or a combination of software and hardware.

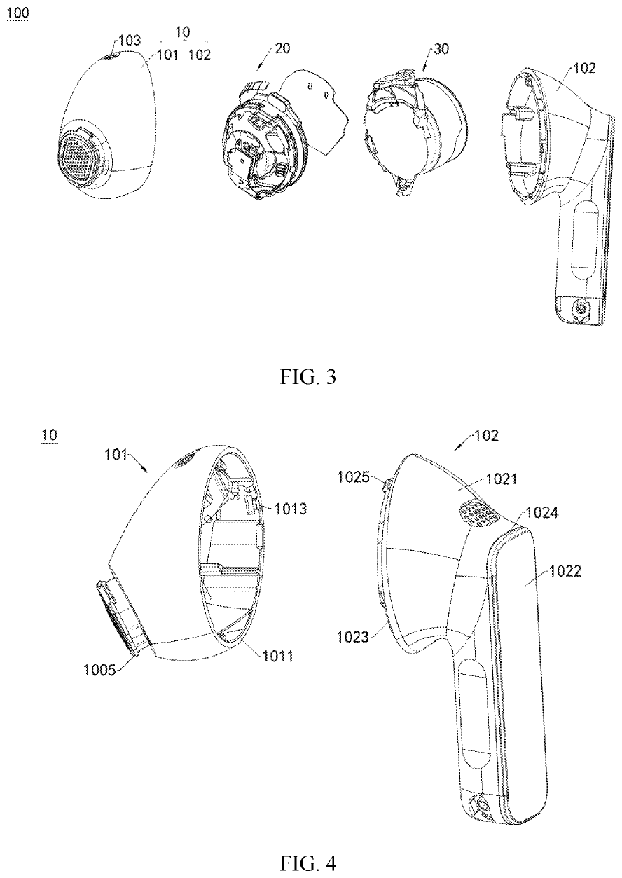

Refer to FIG. 1 and FIG. 3. FIG. 3 is a diagram of an exploded structure of the earphone 100 shown in FIG. 1 in some embodiments.

In some embodiments, the earphone 100 may include a housing 10, an audio assembly 20, and a battery assembly 30.

For example, the housing 10 may be used as a fastening structure and a support structure of the earphone 100. The inside of the housing 10 may be of a hollow structure, and the inside of the housing 10 forms an accommodation space 104. Components such as the audio assembly 20 and the battery assembly 30 may be mounted in the accommodation space 104 of the housing 10 in a fixed manner. When the earphone 100 includes another component, the another component may be mounted in the accommodation space 104 of the housing 10.

The housing 10 may include a first housing 101 and a second housing 102. The first housing 101 and the second housing 102 may be spliced to form the housing 10, and the first housing 101 may be fastened to the second housing 102, to facilitate manufacturing and formation of the housing 10, and facilitate mounting of another component of the earphone 100 on the housing 10. For example, the first housing 101 is fastened to a front side of the second housing 102, and an internal space of the first housing 101 communicates with an internal space of the second housing 102. When the earphone 100 is in a worn state, the first housing 101 is configured to face an ear of the user, one part of structure that is of the second housing 102 and that is connected to the first housing 101 and the first housing 101 jointly form a housing of the ear cup 1001, and the other part of structure of the second housing 102 forms a housing of the stem 1002 of the earphone 100.

For example, a vent hole 103 may be provided on the housing 10, and the vent hole 103 may connect the outside of the housing 10 to the inside of the housing 10.

For example, the sound outlet portion 1005 may be formed on the housing 10.

For example, the audio assembly 20 may be configured to emit a sound, and may also be configured to receive a sound. The audio assembly 20 may include a speaker and a microphone. The speaker may also be referred to as a “loudspeaker”, and is configured to convert an audio electrical signal into a sound signal, to implement sound playing. The microphone is configured to convert a sound signal into an electrical signal, to implement sound pickup. The microphone may be mainly configured to: capture a sound output by the earphone 100, convert the sound into an electrical signal, and transmit the electrical signal to the main control chip for processing, to implement functions such as active noise reduction, voice call, call noise reduction, ambient sound mode, and voice assistant wakeup of the earphone 100.

For example, the battery assembly 30 is configured to supply power to a power-consuming component (for example, the audio assembly 20) of the earphone 100. The battery assembly 30 may be electrically connected to the audio assembly 20, to supply power to the audio assembly 20. For example, the battery assembly 30 may be a lithium battery, but this is not limited thereto.

In the embodiments, during assembly of the earphone 100, the audio assembly 20 may be first mounted on the first housing 101, then the battery assembly 30 is mounted on the second housing 102, and then the first housing 101 and the second housing 102 are spliced. In this case, during assembly of the earphone 100, few modules need to be assembled, and there are few assembly steps, so that assembly efficiency is improved, and the obtained earphone 100 has good consistency.

It may be understood that, the microphone in the earphone 100 may further include a feedforward microphone (not shown in the figure) configured to pick up noise outside the earphone 100, and may further include a sound receiving microphone (not shown in the figure) configured to pick up a sound of the user.

Refer to FIG. 4 and FIG. 5. FIG. 4 is a diagram of an exploded structure of the housing 10 shown in FIG. 1. FIG. 5 is a sectional view of the housing 10 shown in FIG. 1.

In some embodiments, the first housing 101 may be of a cover structure, and the inside of the first housing 101 may form a first space.

For example, an end of the first housing 101 forms the sound outlet portion 1005, and another end forms a first alignment and connection opening 1011. The sound outlet portion 1005 may form a first channel 1012 inside the first housing 101, and the first channel 1012 may connect the first space to the sound outlet holes 1007. The first alignment and connection opening 1011 may be approximately of a circular structure. In a direction from the sound outlet portion 1005 to the first alignment and connection opening 1011, a cross-sectional area of the first housing 101 may first increase and then decrease. The first alignment and connection opening 1011 may be provided with a first snap-fit portion 1013, and the first snap-fit portion 1013 may protrude toward the inside of the first housing 101. In some other embodiments, in the direction from the sound outlet portion 1005 to the first alignment and connection opening 1011, the cross-sectional area of the first housing 101 may alternatively first increase. This is not strictly limited in the embodiments.

At an end that is of the first housing 101 and that is close to the sound outlet portion 1005, a part of an inner wall of the first housing 101 may form a mounting surface 1014. The mounting surface 1014 may be disposed around the first channel 1012. In some examples, the mounting surface 1014 may be a flat surface, and the mounting surface 1014 may be perpendicular to the central axis 1004. In some other embodiments, the mounting surface 1014 may be a non-flat surface.

In some embodiments, the second housing 102 may be of a cover structure, and the inside of the second housing 102 may form a second space.

For example, the second housing 102 may include a main housing 1021 and a rear cover 1022, and the main cover is fastened to the rear cover 1022. An end of the main housing 1021 forms a second alignment and connection opening 1023, and another end forms a third alignment and connection opening 1024. The second alignment and connection opening 1023 may be approximately of a circular structure, and the third alignment and connection opening 1024 may be approximately of a rectangular structure. The rear cover 1022 may be approximately of a rectangular plate structure, and a shape of the rear cover 1022 may be set to correspond to a shape of the third alignment and connection opening 1024. For example, the rear cover 1022 may be fastened to the third alignment and connection opening 1024 and close the third alignment and connection opening 1024. The second alignment and connection opening 1023 may be provided with a second snap-fit portion 1025.

In some embodiments, the first housing 101 is fastened to the second housing 102. In this case, the first space communicates with the second space, to form the accommodation space 104 of the housing 10, so as to mount other components (for example, the audio assembly 20 and the battery assembly 30) inside the housing 10. For example, the first alignment and connection opening 1011 of the first housing 101 is aligned with and connected to the second alignment and connection opening 1023 of the second housing 102, and the first snap-fit portion 1013 is snap-fitted to the second snap-fit portion 1025, so that the first housing 101 is fastened to the second housing 102. This facilitates disassembly and assembly of the first housing 101 and the second housing 102. In some other embodiments, the first housing 101 may alternatively be fastened to the second housing 102 through bonding.

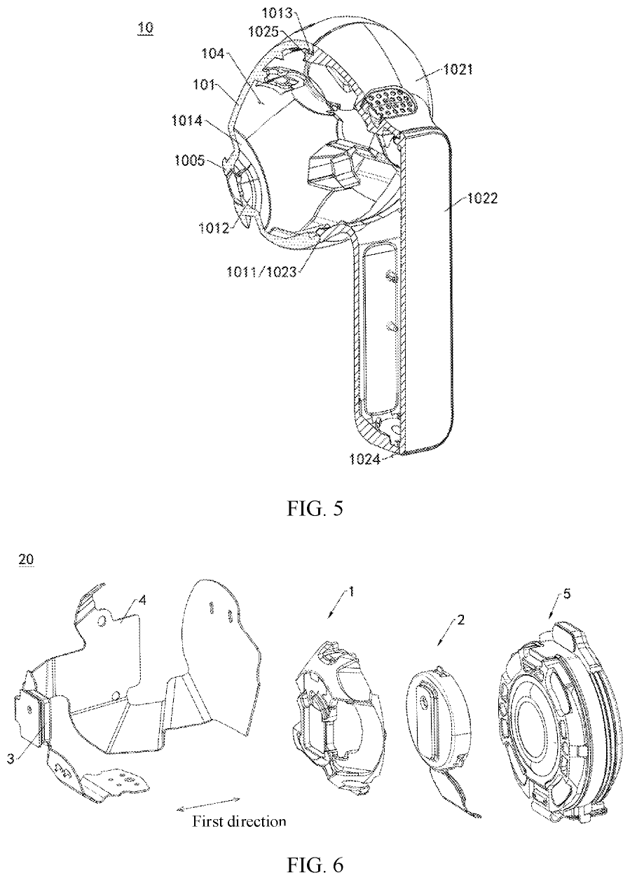

FIG. 6 is a diagram of an exploded structure of the audio assembly 20 shown in FIG. 3 in some embodiments.

In some embodiments, the audio assembly 20 may include a first bracket 1, a first speaker 2, a microphone 3, and a flexible circuit board 4.

The first bracket 1 is used for fixed mounting of the first speaker 2 and the microphone 3. The first speaker 2 is configured to play a sound, and a second speaker 5 is configured to pick up a sound. The flexible circuit board 4 is configured to electrically connect to the first speaker 2 and the microphone 3, and the flexible circuit board 4 is further configured to communicatively connect to a circuit board, so that the circuit board communicates with the first speaker 2 and the microphone 3. In this way, the first speaker 2 implements a sound playing function, and the microphone 3 implements a sound pickup function.

In some embodiments, the audio assembly 20 may further include a second speaker 5. The first bracket 1 is further used for fixed mounting of the second speaker 5. The first bracket 1, the first speaker 2, and the second speaker 5 are sequentially stacked in a first direction. The first direction may be parallel to the central axis 1004. The second speaker 5 may be electrically connected to the flexible circuit board 4. The second speaker 5 is configured to play a sound. Both the first speaker 2 and the second speaker 5 are configured to play sounds. In this case, the first speaker 2 may be configured to play a treble sound, and the second speaker 5 may be configured to play mid and bass sounds. Sounds of different frequencies are played by the first speaker 2 and the second speaker 5 respectively. This facilitates utilization of respective characteristics of the first speaker 2 and the second speaker 5, to help improve sound quality of the audio assembly 20. In addition, the second speaker 5 is also stacked in the first direction, which is the same as a direction in which the microphone 3, the first bracket 1, and the first speaker 2 are arranged. This facilitates mounting of the second speaker 5 on the first bracket 1.

It may be understood that, when the audio assembly 20 includes the first speaker 2 but does not include the second speaker 5, the first speaker 2 may be a full-frequency speaker configured to play sounds of full frequencies.

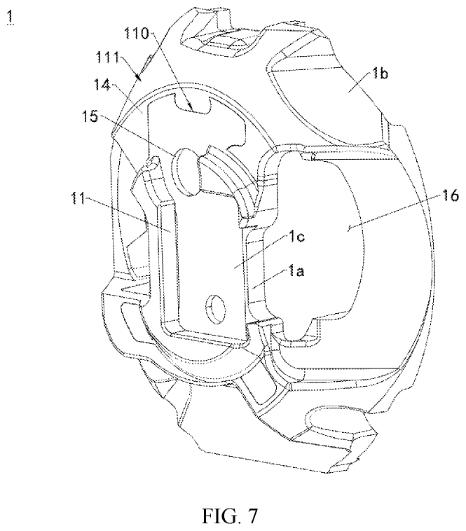

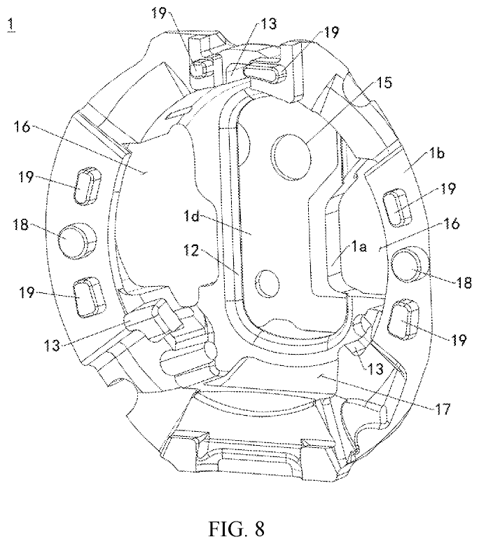

Refer to FIG. 7 and FIG. 8. FIG. 7 is a diagram of a structure of the first bracket 1 shown in FIG. 6 in some embodiments. FIG. 8 is a diagram of a structure of the first bracket 1 shown in FIG. 7 from another viewpoint. The viewpoint in FIG. 8 is a reverse viewpoint of the viewpoint in FIG. 7.

In some embodiments, the first bracket 1 may be approximately of a cover structure.

For example, the first bracket 1 may include a top portion 1a and a side portion 1b, and the top portion 1a is fastened to the side portion 1b. The side portion 1b may be approximately annular, the side portion 1b may be disposed around the top portion 1a, the top portion 1a is fastened to an end of the side portion 1b, another end of the side portion 1b forms an open port, and the top portion 1a and the side portion 1b can enclose a cover space.

For example, the first bracket 1 may be provided with a first mounting groove 11. The first mounting groove 11 may be formed outside the first bracket 1 and exposed from an outer surface of the first bracket 1. For example, the first mounting groove 11 may be formed on a side that is of the top portion 1a and that faces away from the cover space of the first bracket 1. In this case, an opening direction of the first mounting groove 11 also faces away from the cover space. The first mounting groove 11 may be approximately of a rectangular groove structure, but this is not strictly limited thereto.

For example, the first bracket 1 may be provided with a second mounting groove 12. The second mounting groove 12 may be formed inside the first bracket 1. For example, the second mounting groove 12 may be formed on a side that is of the top portion 1a and that is located in the cover space. In this case, an opening direction of the second mounting groove 12 faces away from the first mounting groove 11. The second mounting groove 12 may be approximately of a rectangular groove structure, but this is not strictly limited thereto.

For example, the first bracket 1 may be provided with a positioning groove 13. The positioning groove 13 may be formed inside the first bracket 1. For example, the positioning groove 13 may be formed on the side portion 1b. There may be a plurality of positioning grooves 13, and the plurality of positioning grooves 13 may be spaced from each other in a circumferential direction of the side portion 1b. For example, there may be three positioning grooves 13.

For example, the first bracket 1 may include a first surface 1c. The first surface 1c is formed on a side of the top portion 1a. For example, the first surface 1c is at least partially formed on a bottom surface of the first mounting groove 11. The first surface 1c may be a flat surface, but this is not strictly limited thereto. The first surface 1c may be configured to be fastened to the first speaker 2. The side portion 1b extends facing away from the first surface 1c.

For example, the first bracket 1 may include a second surface 1d. The second surface 1d faces away from the first surface 1c. In other words, an included angle between a positive direction of a normal of the first surface 1c (for a surface of an entity, a positive direction of a normal is a direction from the inside of the entity to the outside of the entity) and a positive direction of a normal of the second surface 1 d is greater than 90°. The second surface 1d is formed on another side of the top portion 1a. For example, the second surface 1d is formed on a bottom wall surface of the second mounting groove 12 on the top portion 1a, and the second surface 1d may be parallel to the first surface 1c. The second surface 1d may be a flat surface, but this is not strictly limited thereto. The second surface 1d may be configured to fasten the first bracket 1 to the housing 10. In some other embodiments, the second surface 1d may alternatively be formed on the side portion 1b. This is not specifically limited herein.

For example, the first bracket 1 may include a fastened surface 14. For example, the fastened surface 14 may be formed by a part of a surface of the top portion 1a. The fastened surface 14 may be connected to the side portion 1b. For example, the fastened surface 14 may be coplanar with the first surface 1c, so that the first surface 1c and the fastened surface 14 can be synchronously formed. In some other embodiments, the fastened surface 14 may not be coplanar with the first surface 1c. The fastened surface 14 may be configured to fasten the first bracket 1 to the housing 10.

For example, the first bracket 1 may be provided with a first through hole 15. For example, the first through hole 15 may run through the top portion 1a of the first bracket 1. In some examples, the first through hole 15 may be a circular hole.

For example, the first bracket 1 may be provided with a second through hole 16. The second through hole 16 may be provided at a connection between the top portion 1a and the side portion 1b. For example, an area of the second through hole 16 may be greater than an area of the first through hole 15. For example, there may be two second through holes 16, and the two second through holes 16 may be distributed on two sides of the first through hole 15.

For example, the first bracket 1 may be provided with a third through hole 17. The third through hole 17 may run through the first bracket 1. The third through hole 17 may be provided at a connection between the top portion 1a and the side portion 1b. The cover space inside the first bracket 1 may communicate with a space outside the first bracket 1 through the first through hole 15, the second through hole 16, and/or the third through hole 17.

For example, the first bracket 1 may include a positioning pillar 18. For example, the positioning pillar 18 may be formed at an end that is of the side portion 1b and that is away from the top portion 1a. The positioning pillar 18 may protrude. The positioning pillar 18 may be approximately of a cylindrical structure. There may be a plurality of positioning pillars 18, and the plurality of positioning pillars 18 may be spaced from each other. The positioning pillar 18 may be configured to determine relative positions of the first bracket 1 and another component.

For example, the first bracket 1 may include a fastening pillar 19. For example, the fastening pillar 19 may be formed at the end that is of the side portion 1b and that is away from the top portion 1a. The fastening pillar 19 may protrude. The fastening pillar 19 may be approximately of a rectangular pillar structure. In this example, the positioning pillar 18 and the fastening pillar 19 may be used together. The fastening pillar 19 may be configured to fix the relative positions of the first bracket 1 and the another component.

In some examples, two fastening pillars 19 may be located on two sides of one positioning pillar 18 respectively, and the two fastening pillars 19 and the positioning pillar 18 may form one group of positioning and fastening structures. In some examples, the first bracket 1 may include a plurality of groups of positioning and fastening structures.

In this example, the first bracket 1 forms a cover structure, and the cover structure may form a cover space. This facilitates mounting of another component on the first bracket 1, and enables the first bracket 1 to have light mass.

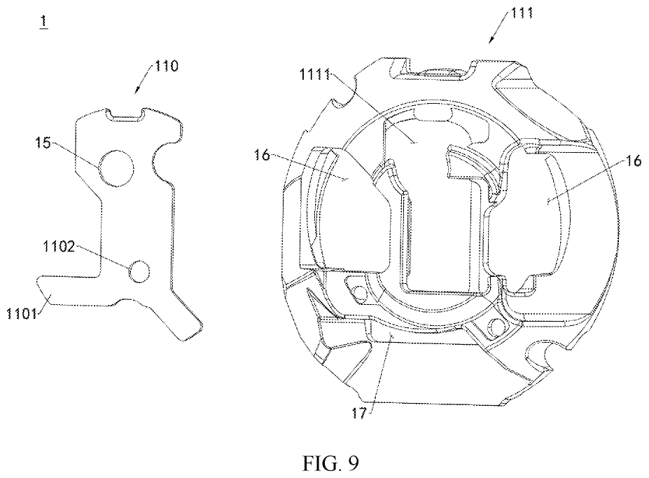

Refer to FIG. 7 and FIG. 9. FIG. 9 is a diagram of an exploded structure of the first bracket 1 shown in FIG. 7 in some embodiments.

In some embodiments, the first bracket 1 may include a fastened portion 110 and a main portion 111. The fastened portion 110 may be fastened to the main portion 111. A part of a structure of the fastened portion 110 is configured to form a bottom wall of the first mounting groove 11. In other words, the fastened portion 110 may form one part of structure of the top portion 1a, and the main portion 111 may form the side portion 1b and the other part of structure of the top portion 1a.

For example, the first through hole 15 may be provided on the fastened portion 110. A surface that is of the fastened portion 110 and that is exposed from the first bracket 1 may be smoothly connected to and coplanar with a surface of the main portion 111. In other words, the first surface 1c of the first bracket 1 may be formed by the surface of the fastened portion 110, and the fastened surface 14 of the first bracket 1 is formed by a part of the surface of the main portion 111 and a part of the surface of the fastened portion 110.

For example, the second through hole 16, the third through hole 17, and the positioning groove 13 may be provided on the main portion 111. The fastening pillar 19 and the positioning pillar 18 may be formed on the main portion 111.

For example, the bottom wall of the first mounting groove 11 may be formed by the fastened portion 110, and a side wall of the first mounting groove 11 may be formed by the main portion 111. The second mounting groove 12 may also be formed by the fastened portion 110 and the main portion. It may be understood that the second surface 1d may be formed by a part of a surface of the fastened portion 110.

For example, the main portion 111 may be provided with an embedded hole 1111, and the embedded hole 1111 runs through the main portion 111. The embedded hole 1111 may be a hole of an irregular shape, and a shape of the embedded hole 1111 may be set to correspond to a shape of the fastened portion 110.

For example, the fastened portion 110 may include an embedded portion 1101, and the embedded portion 1101 is configured to be embedded in the main portion 111. When the fastened portion 110 is fastened to the main portion 111, the fastened portion 110 covers the embedded hole 1111.

For example, the fastened portion 110 may be provided with a fourth through hole 1102, and the fourth through hole 1102 is used for positioning of the fastened portion 110 when the fastened portion 110 and the main portion 111 are integrally formed.

In some embodiments, the fastened portion 110 and the main portion 111 may be an integrally formed mechanical part.

For example, the fastened portion 110 may be made of metal, the main portion 111 may be made of plastic, and the fastened portion 110 may be embedded in the main portion 111. For example, the fastened portion 110 may be of a plate structure, to facilitate formation. For example, the fastened portion 110 may be a metal sheet such as a steel sheet. The main portion 111 may be formed through injection molding, and the fastened portion 110 may be embedded in an injection mold, so that when the main portion 111 is formed, the fastened portion 110 and the main portion 111 can be integrally formed. In this example, the fastened portion 110 is made of a metal material, so that the fastened portion 110 can have high strength and a small thickness, to facilitate a thinning design of the audio assembly 20. The main portion 111 is made of a plastic material. This helps reduce a weight of the main portion 111, to reduce a weight of the first bracket 1. In addition, this facilitates formation of the main portion 111, and can reduce manufacturing costs of the main portion 111.

In some other examples, the fastened portion 110 and the main portion 111 may be integrally formed by using a same material. For example, the first bracket 1 may be formed through injection molding, to synchronously form the fastened portion 110 and the main portion 111.

In some other embodiments, the fastened portion 110 and the main portion 111 may alternatively be split mechanical parts, and the fastened portion 110 and the main portion 111 are assembled to form the first bracket 1.

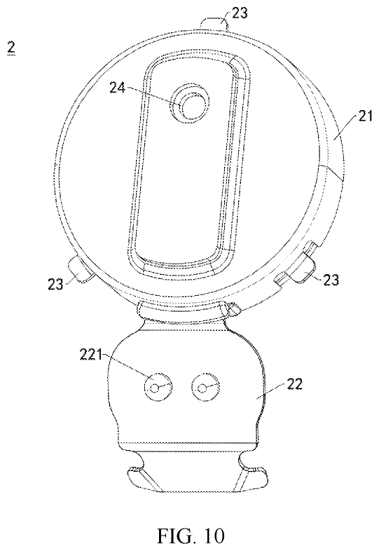

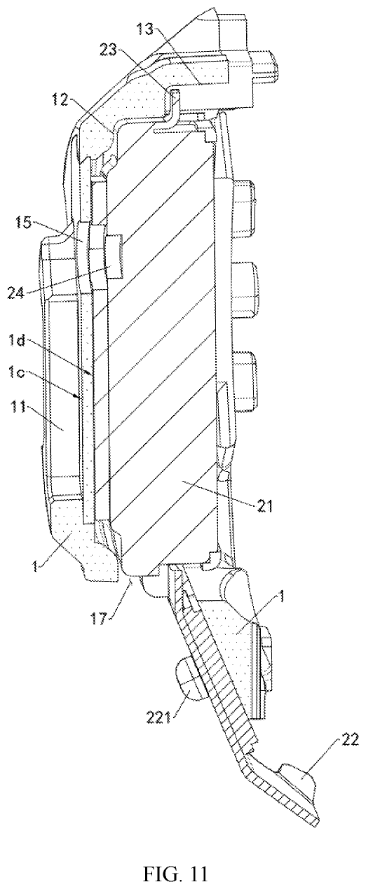

FIG. 10 is a diagram of a structure of the first speaker 2 shown in FIG. 6 in some embodiments.

In some embodiments, the first speaker 2 may include a first body 21 and a first wiring portion 22. The first wiring portion 22 is fastened to the first body 21.

For example, the first body 21 is a sound-emitting structure of the first speaker 2. For example, the first body 21 may emit a sound through vibration of a diaphragm. The sound-emitting structure and a sound-emitting principle of the first speaker 2 are not strictly limited in the embodiments.

For example, the first wiring portion 22 may be flexible. In this case, the first wiring portion 22 can be deformed and bent relative to the first body 21, to facilitate adjustment of relative positions of the first wiring portion 22 and the first body 21.

For example, the first wiring portion 22 may be electrically connected to the first body 21. The first wiring portion 22 may include a first welding joint 221. The first welding joint 221 is configured to electrically connect to another component, so that the another component is electrically connected to the first body 21. For example, the first welding joint 221 may be exposed from the first wiring portion 22. There may be two first welding joints 221.

For example, the first speaker 2 may include a positioning portion 23, and the positioning portion 23 may be formed on the first body 21. For example, the first body 21 may be approximately of a cylindrical structure. The positioning portion 23 may be located on a cylinder side surface of the first body 21. For example, there may be a plurality of positioning portions 23. For example, there are three positioning portions 23, and the three positioning portions 23 are arranged in a circumferential direction of the first body 21. The three positioning portions 23 enable more connections between the first speaker 2 and the first bracket 1. This helps improve stability of connection between the first speaker 2 and the first bracket 1.

For example, the first speaker 2 may be provided with a sound-emitting opening 24, and the sound-emitting opening 24 may be provided on the first body 21. A sound emitted by the first body 21 may be propagated to the outside of the first speaker 2 through the sound-emitting opening 24. For example, the sound-emitting opening 24 may be provided on a surface of the first body 21, and the sound-emitting opening 24 may communicate with the inside of the first body 21.

FIG. 11 is a sectional view of a partial structure of the audio assembly 20 shown in FIG. 3 in some embodiments.

In some embodiments, the first speaker 2 may be mounted on the first bracket 1 in a fixed manner. For example, the first speaker 2 may be bonded to the first bracket 1.

For example, the first body 21 of the first speaker 2 may be located in the cover space of the first bracket 1.

A size of the second mounting groove 12 may be set to correspond to a size of the first speaker 2. At least a part of a structure of the first speaker 2 is located in the second mounting groove 12, and is fastened to the second mounting groove 12, to be fastened to the second surface 1d (as shown in FIG. 8). The sound-emitting opening 24 may be provided corresponding to the first through hole 15, and the sound-emitting opening 24 may communicate with the first through hole 15. In the embodiments, the second mounting groove 12 is provided, so that the second mounting groove 12 can be used for positioning of the first speaker 2, and also used for fixed mounting of the first speaker 2.

The positioning portion 23 of the first body 21 may be located in the positioning groove 13 of the first bracket 1, and the positioning groove 13 and the positioning portion 23 may be connected in a one-to-one correspondence. The positioning portion 23 may be bonded to a wall surface of the positioning groove 13, so that the first speaker 2 is more reliably fastened to the first bracket 1. In this case, the positioning groove 13 is used for positioning of the first speaker 2 in the first bracket 1, and is further configured to connect the first speaker 2 to the first bracket 1. The positioning portion 23 of the first speaker 2 is mounted in the positioning groove 13, the positioning portion 23 is a partial structure of the first speaker 2, and volumes of both the positioning portion 23 and the positioning groove 13 may be set to be small, to facilitate selection of a proper position on the first bracket 1 for providing of the positioning groove 13, and facilitate selection of a proper position on the first speaker 2 for formation of the positioning portion 23, so as to further simplify a structure design of the first bracket 1 and the first speaker 2.

For example, the first wiring portion 22 of the first speaker 2 may pass through the third through hole 17 and extend to the outside of the first bracket 1. This facilitates welding of the first wiring portion 22 to another component during mounting of the first speaker 2 on the first bracket 1.

In some other embodiments, the first speaker 2 may alternatively be fastened to the first bracket 1 through a snap-fit, threaded connection by using a fastener, or the like.

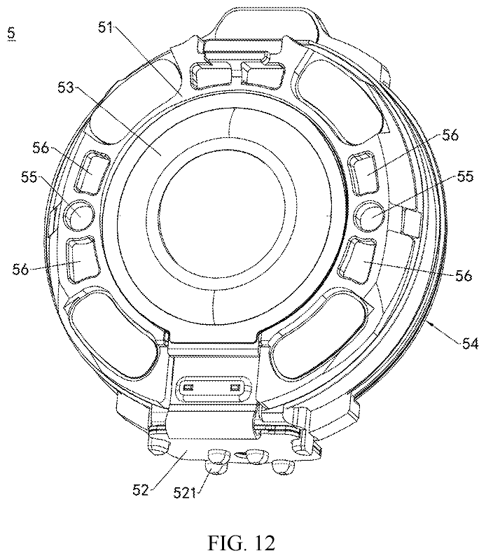

FIG. 12 is a diagram of a structure of the second speaker 5 shown in FIG. 6 in some embodiments.

In some embodiments, the second speaker 5 may include a second body 51 and a second wiring portion 52. The second wiring portion 52 is fastened to the second body 51.

For example, the second body 51 is a sound-emitting structure of the second speaker 5. For example, the second body 51 may emit a sound through vibration of a diaphragm.

In some examples, the second speaker 5 may include a first sub-speaker 53 and a second sub-speaker 54, the first sub-speaker 53 is fastened to the second sub-speaker 54, and each of the first sub-speaker 53 and the second sub-speaker 54 is capable of emitting a sound. The first sub-speaker 53 may face away from the second sub-speaker 54. Both the first sub-speaker 53 and the second sub-speaker 54 can emit sounds, and the first sub-speaker 53 and the second sub-speaker 54 may emit sounds in a same direction based on an internal channel design.

The first sub-speaker 53 and the second sub-speaker 54 may emit sounds simultaneously, or may emit sounds separately. For example, each of the first sub-speaker 53 and the second sub-speaker 54 includes a diaphragm, and emits a sound by using the respective diaphragm. For example, the first sub-speaker 53 and the second sub-speaker 54 may be formed separately and then connected as a whole, to form the second speaker 5. For example, the first sub-speaker 53 and the second sub-speaker 54 may reuse a structure for driving the diaphragm, such as a magnet or a coil. Structures of the first sub-speaker 53 and the second sub-speaker 54 are not strictly limited in the examples. For example, the first sub-speaker 53 is mainly configured to emit a mid-frequency sound, and the second sub-speaker 54 is mainly configured to emit a low-frequency sound, but this is not limited thereto.

In this case, both the first speaker 2 and the second speaker 5 can emit sounds, which helps improve sound quality of the earphone 100. The first sub-speaker 53 and the second sub-speaker 54 are integrated to form the second speaker 5, which can improve a degree of integration of the first sub-speaker 53 and the second sub-speaker 54 and reduce an occupied space. The first speaker 2 and the second speaker 5 can also be assembled together into the earphone 100, which improves assembly efficiency.

In some examples, the second speaker 5 may be mainly configured to emit sounds of mid and low frequencies, to be used with the first speaker 2. In some other examples, the second speaker 5 may alternatively be configured to emit a high-frequency sound, or emit sounds of full frequencies. This is not strictly limited in the examples.

For example, the second wiring portion 52 may be flexible. In this case, the second wiring portion 52 can be deformed and bent relative to the second body 51, to facilitate adjustment of relative positions of the second wiring portion 52 and the second body 51.

For example, the second wiring portion 52 may be electrically connected to the second body 51. The second wiring portion 52 may include a second welding joint 521. The second welding joint 521 is configured to electrically connect to another component, so that the another component is electrically connected to the second body 51. For example, the second welding joint 521 may be exposed from the second wiring portion 52. There may be four second welding joints 521. Two second welding joints 521 are configured to electrically connect to the first sub-speaker 53, and the other two second welding joints 521 are configured to electrically connect to the second sub-speaker 54. In some other embodiments, a quantity of second welding joints 521 may be set based on a structure of the second speaker 5.

For example, the second body 51 may be approximately of a cylindrical structure. The second wiring portion 52 may be connected to an end surface of the second body 51, and partially fastened to a side surface of the second body 51. The second welding joint 521 may be exposed from an outer surface of the second wiring portion 52.

In some embodiments, the second speaker 5 may be provided with a positioning hole 55. For example, the positioning hole 55 may be provided on an end surface of the second body 51. For example, there may be a plurality of positioning holes 55, and the plurality of positioning holes 55 are spaced from each other on the end surface of the second body 51. For example, there may be two positioning holes 55.

In some embodiments, the second speaker 5 may be provided with a fastening hole 56. For example, the fastening hole 56 may be provided on an end surface of the second body 51. For example, there may be a plurality of fastening holes 56, and the plurality of fastening holes 56 are spaced from each other on the end surface of the second body 51. A part of the fastening holes 56 may be provided adjacent to the positioning hole 55. For example, there may be six fastening holes 56. Two fastening holes 56 are located on two sides of one positioning hole 55. The fastening hole 56 and the positioning hole 55 may alternatively be arranged in another manner. This is not strictly limited in the embodiments.

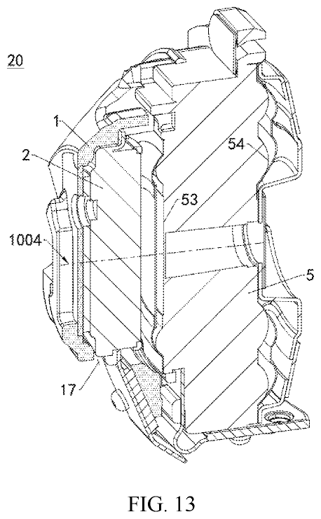

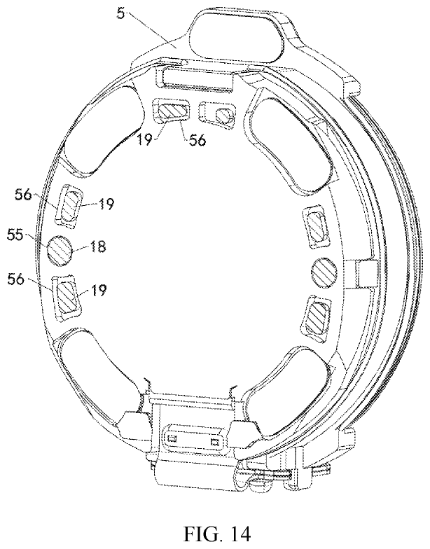

Refer to FIG. 13 and FIG. 14. FIG. 13 is a sectional view of a partial structure of the audio assembly 20 shown in FIG. 3 in some embodiments. FIG. 14 is a sectional view of a partial structure of the audio assembly 20 shown in FIG. 3 in some other embodiments. A sectional plane in FIG. 13 is parallel to the central axis 1004, and a sectional plane in FIG. 14 is perpendicular to the central axis 1004.

In some embodiments, the second speaker 5 may be mounted on the first bracket 1 in a fixed manner. For example, the second speaker 5 may be bonded to the first bracket 1. The first bracket 1, the first speaker 2, and the second speaker 5 are sequentially stacked in the first direction. The first direction may be parallel to the central axis 1004. In this case, both the first speaker 2 and the second speaker 5 belong to the audio assembly 20, both the first speaker 2 and the second speaker 5 can emit sounds, and the first speaker 2 and the second speaker 5 may be responsible for sounds of different frequencies. This helps improve respective sound quality of the first speaker 2 and the second speaker 5, to improve sound quality of the earphone 100.

For example, the second speaker 5 is mounted on an end portion of the first bracket 1, the first bracket 1 and the second speaker 5 enclose a mounting space, the first speaker 2 is located in the mounting space, and the first speaker 2 is spaced from the second speaker 5. A cross section of the second speaker 5 may be larger than a cross section of the first speaker 2, and a size of an end surface of the second speaker 5 may be close to a size of the end portion that is of the first bracket 1 and that is aligned with and connected to the second speaker. The end surface of the second speaker 5 closes the cover space of the first bracket 1, to form the mounting space, and the first speaker 2 is located in the mounting space. The first sub-speaker 53 of the second speaker 5 may be located on a side facing the first speaker 2. Because the mounting space may communicate with the outside through the second through hole 16 (as shown in FIG. 7) or the third through hole 17 of the first bracket 1, a sound of the first sub-speaker 53 can be propagated to the outside of the first bracket 1 through the mounting space and the second through hole 16 or the third through hole 17.

In this example, the first speaker 2 and the second speaker 5 are fastened to the first bracket 1, and the first speaker 2 is surrounded by the first bracket 1 and the second speaker 5. In this way, structures of the first bracket 1, the first speaker 2, and the second speaker 5 can be more compact, and space utilization is higher, to help improve miniaturization of the audio assembly 20. In addition, this facilitates fastening of the first speaker 2 and the second speaker 5 to the first bracket 1.

For example, the positioning pillar 18 of the first bracket 1 is in a clearance fit with the positioning hole 55 of the second speaker 5, the fastening pillar 19 of the first bracket 1 is located in the fastening hole 56 of the second speaker 5, and the fastening pillar 19 is bonded to the fastening hole 56 by using an adhesive. A shape of the positioning pillar 18 may match a shape of the positioning hole 55. For example, the positioning pillar 18 may be of a cylindrical pillar structure, the positioning hole 55 may be of a cylindrical hole structure, and a diameter of the positioning pillar 18 may be less than or equal to a diameter of the positioning hole 55. A size of the fastening pillar 19 may be less than a size of the fastening hole 56, and there may be a spacing between an outer wall of the fastening pillar 19 and an inner wall of the fastening hole 56. A shape of the fastening pillar 19 may be different from or the same as a shape of the fastening hole 56. For example, both the fastening pillar 19 and the fastening hole 56 may be approximately of a rectangular pillar structure. The spacing between the fastening pillar 19 and the fastening hole 56 may be filled with the adhesive, so that the fastening pillar 19 is fastened to the fastening hole 56, and the second speaker 5 is fastened to the first bracket 1. The spacing between the fastening hole 56 and the fastening pillar 19 helps increase a bonding area of the adhesive between the fastening hole and the fastening pillar, to improve bonding reliability.

In this example, the positioning hole 55 and the positioning pillar 18 are disposed, to facilitate positioning of the second speaker 5 on the first bracket 1 during mounting of the second speaker 5. The fastening hole 56 and the fastening pillar 19 are disposed, and are bonded by using the adhesive, so that connection between the second speaker 5 and the first bracket 1 is simpler and reliable.

For example, as described above, when the second speaker 5 includes the first sub-speaker 53 and the second sub-speaker 54, the first sub-speaker 53 and the second sub-speaker 54 may be arranged in the first direction, the first sub-speaker 53 may face the first speaker 2, and the second sub-speaker 54 may face away from the first speaker 2 relative to the first sub-speaker 53.

In some other embodiments, the second speaker 5 may alternatively be fastened to the first bracket 1 in a connection manner such as welding or a snap-fit.

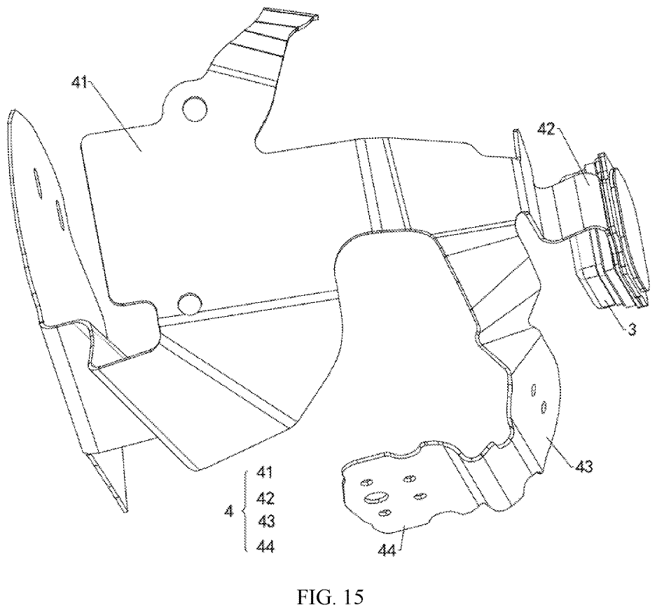

FIG. 15 is a diagram of structures of the flexible circuit board 4 and the microphone 3 shown in FIG. 6.

In some embodiments, the flexible circuit board 4 may include a mainboard portion 41, a first electrical connection portion 42, a second electrical connection portion 43, and a third electrical connection portion 44. The first electrical connection portion 42, the second electrical connection portion 43, and the third electrical connection portion 44 are all fastened to the mainboard portion 41.

For example, the first electrical connection portion 42 is fastened to the mainboard portion 41, the second electrical connection portion 43 is fastened to the mainboard portion 41, and the third electrical connection portion 44 is fastened to the second electrical connection portion 43. The third electrical connection portion 44 is fastened to the mainboard portion 41 through the second electrical connection portion 43. The first electrical connection portion 42, the second electrical connection portion 43, and the third electrical connection portion 44 may extend from the mainboard portion 41.

It may be understood that the flexible circuit board 4 may include a circuit, for transmission of an electrical signal.

In some embodiments, the microphone 3 can convert a sound signal into an electrical signal for output, to pick up a sound. For example, the microphone 3 may be a feedback microphone 3, and the microphone 3 may be configured to pick up a sound output by the earphone 100.

In some embodiments, the flexible circuit board 4 and the microphone 3 may be an integrally formed mechanical part. The microphone 3 may be formed by using a semiconductor process. During formation of the microphone 3, the microphone may be directly formed on the first electrical connection portion 42 of the flexible circuit board 4. After the microphone is manufactured, the microphone 3 may be fastened to the first electrical connection portion 42. In this way, electrical connection between the microphone 3 and the flexible circuit board 4 is more reliable, and when the audio assembly 20 is assembled, steps of fastening the microphone 3 and the flexible circuit board 4 are reduced, to facilitate assembly of the audio assembly.

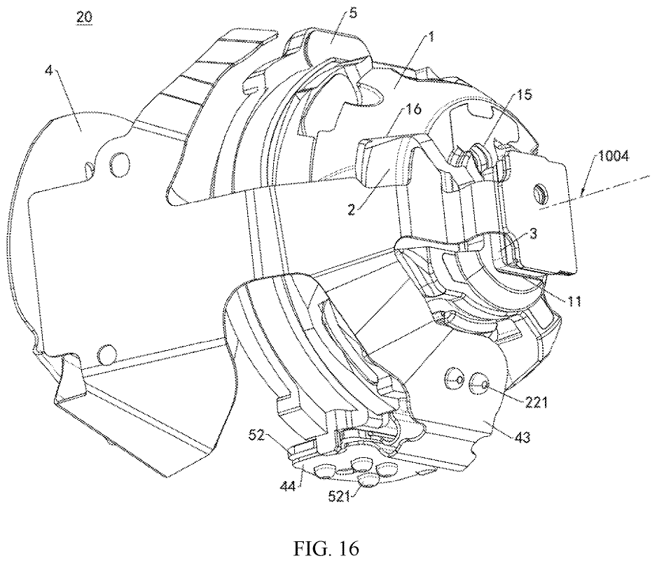

FIG. 16 is a sectional view of a partial structure of the audio assembly 20 shown in FIG. 3 in still some other embodiments.

In some embodiments, both the microphone 3 and the first speaker 2 may be fastened to the first bracket 1. For example, with reference to FIG. 7, the microphone 3 may be fastened to the first mounting groove 11, so that the microphone 3 is fastened to the first surface 1c.

A size of the first mounting groove 11 may be set to correspond to a size of the microphone 3. At least a part of a structure of the microphone 3 is located in the first mounting groove 11. In the embodiments, the first mounting groove 11 is provided, so that the first mounting groove 11 can be used for positioning of the microphone 3, and also used for mounting of the microphone 3. The microphone 3 is generally small, and the first mounting groove 11 is equivalent to surrounding at least the part of the structure of the microphone 3, so that a groove structure of the first mounting groove 11 can have more contact surfaces and a larger contact area with the microphone 3. In this way, the microphone 3 is more reliably fastened.

In a direction perpendicular to the central axis 1004, the microphone 3 avoids the first through hole 15, to avoid blocking the first through hole 15, so that the first through hole 15 can keep in communication with the outside of the first bracket 1.

In some embodiments, the flexible circuit board 4 may be electrically connected to the first speaker 2 and the second speaker 5. The second electrical connection portion 43 may be welded to the two first welding joints 221, and two welding points may be formed after the welding. The third electrical connection portion 44 may be welded to the four second welding joints 521 of the second wiring portion 52. In this case, because the flexible circuit board 4 and the microphone 3 are an integrally formed mechanical part, when the microphone 3 is fastened to the first bracket 1, a step of electrically connecting the flexible circuit board 4 to the first speaker 2 and the second speaker 5 may be synchronously performed, to simplify a step of assembling the audio assembly 20.

In some embodiments, as described above, with reference to FIG. 11, because the first wiring portion 22 may pass through the third through hole 17 and extend to the outside of the first bracket 1, it is easy to weld the flexible circuit board 4 to the first wiring portion 22 outside the first bracket 1. Because the second speaker 5 is mounted on the end portion of the first bracket 1 and the second wiring portion 52 is located on a side surface of the second speaker 5, the second wiring portion 52 is also located outside the first bracket 1, so that it is easy to weld the flexible circuit board 4 to the second wiring portion 52 outside the first bracket 1. In this case, manners of electrically connecting the flexible circuit board 4 to the microphone 3, the first speaker 2, and the second speaker 5 are simple, the flexible circuit board 4 may cover the outside of the microphone 3, the first bracket 1, the first speaker 2, and the second speaker 5, and no additional arrangement is required for the flexible circuit board 4. In this way, mounting of the flexible circuit board 4 is simple and convenient.

In embodiments of this disclosure, the microphone 3, the first bracket 1, and the first speaker 2 of the audio assembly 20 are stacked in the first direction.

In this case, the microphone 3 and the first speaker 2 are located on different surfaces of the first bracket 1, and the microphone 3 and the first speaker 2 are fastened to the first bracket 1. The first bracket 1 is used for separate fastening of the microphone 3 and the first speaker 2, so that the first bracket 1 has little impact on a size of the audio assembly 20 in the first direction. This helps reduce the size of the audio assembly 20 in the first direction, to improve compactness of a structure of the audio assembly 20. In addition, the microphone 3 and the first speaker 2 are located on different sides of the first bracket 1, so that mounting of the microphone 3 and mounting of the first speaker 2 do not affect each other. This facilitates assembly of the microphone 3 and the first speaker 2. Moreover, the microphone 3, the first bracket 1, the first speaker 2, and the like may be first assembled to form an independent module (the audio assembly 20), there is substantially no need to consider impact of another component (for example, the housing 10) of the earphone 100 on the microphone 3, the first bracket 1, and the first speaker 2 during assembly, and a space during assembly is large. This helps improve accuracy and consistency in mounting the module (the audio assembly 20) in the housing 10.

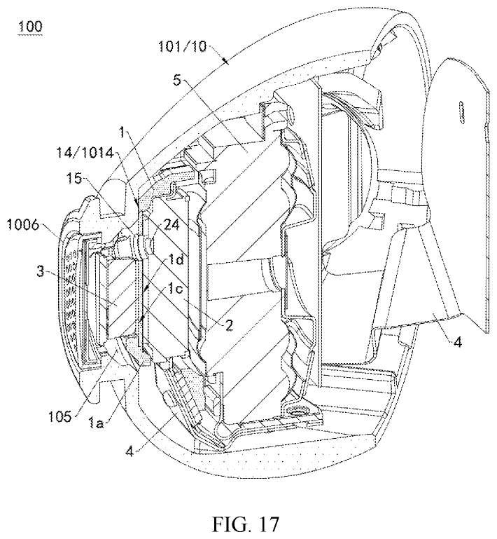

Refer to FIG. 5, FIG. 16, and FIG. 17. FIG. 17 is a sectional view of a partial structure of the earphone 100 shown in FIG. 1 in some embodiments.

In some embodiments, the audio assembly 20 may be mounted in the accommodation space 104 of the housing 10. The first bracket 1 and the housing 10 enclose a sound outlet channel 105, and the sound outlet channel 105 connects the accommodation space 104 to the outside of the housing 10. In this case, the first speaker 2 may propagate a sound to the outside of the earphone 100 through the sound outlet channel 105, so that the earphone 100 can emit a sound normally. In addition, the microphone 3 may be located in the sound outlet channel 105, to facilitate sound pickup.

For example, the sound outlet channel 105 may communicate with the outside through the sound outlet opening 1006. In other words, the sound outlet opening 1006 connects the sound outlet channel 105 to a space outside the housing 10. In addition, the microphone 3 may be located on a side that is of the first bracket 1 and that faces the sound outlet opening 1006. In this case, the sound outlet channel 105 is enclosed by the first bracket 1 and the housing 10, the microphone 3 is located in the sound outlet channel 105, the microphone 3 is close to the sound outlet opening 1006, and a sound at the sound outlet opening 1006 is directly transmitted to a human ear, so that a sound picked up by the microphone 3 is closer to a sound actually heard by the human ear. This facilitates noise reduction of the earphone 100. In addition, the microphone 3 is fastened to the first bracket 1. In other words, there is no need to fasten the microphone 3 to the housing 10 at the sound outlet opening 1006, so that the sound outlet channel 105 at the sound outlet opening 1006 is not blocked. This helps the sound outlet channel 105 have a larger sound outlet area, to improve sound outlet effect.

The first surface 1c may face the sound outlet opening 1006. The first through hole 15 may connect the sound-emitting opening 24 to the sound outlet channel. When the first speaker 2 is bonded to the first bracket 1, the adhesive may avoid the first through hole 15, so that the first through hole 15 communicates with the sound-emitting opening 24 and sealing at a connection is kept. The adhesive has a function of bonding the first speaker 2 to the first bracket 1, and also has a sealing function. In this case, the microphone 3 can face the sound outlet opening 1006, a sound emitted by the earphone 100 can be picked up by the microphone 3, and a sound at the sound outlet opening 1006 can be directly propagated to the microphone 3, so that a propagation path is simpler. This facilitates sound pickup by the microphone 3. In addition, because the first through hole 15 connects the sound-emitting opening 24 to the sound outlet channel 105, a path between the sound-emitting opening 24 of the first speaker 2 and the sound outlet opening 1006 is substantially a straight line. In other words, the sound outlet channel 105 used by the first speaker 2 to output a sound through the sound outlet opening 1006 has a simple structure, and has little impact on the sound. This helps improve sound quality of the earphone 100, and a simple sound outlet path helps simplify a structure of the earphone 100.

For example, the fastened surface 14 (as shown in FIG. 7) of the first bracket 1 is fastened to the mounting surface 1014 (as shown in FIG. 5) of the first housing 101. For example, the first surface 1c may be bonded to the mounting surface 1014 by using an adhesive.

As described above, the fastened surface 14 may be a flat surface, and the fastened surface 14 may be perpendicular to the first direction. In other words, the fastened surface 14 may be perpendicular to the central axis 1004. In this case, the fastened surface 14 being a flat surface facilitates formation of the fastened surface 14, to simplify manufacturing of the first bracket 1. The fastened surface 14 is in contact with the mounting surface 1014 of the housing 10. This helps increase a bonding area, to improve fastening reliability. Because the fastened surface 14 is bonded to the housing 10, and a direction of force applied to the fastened surface 14 is parallel to the first direction, during assembly of the audio assembly 20, the fastened surface 14 may be mounted in the first direction, which is the same as a direction in which components in the audio assembly 20 are assembled. This reduces assembly directions, and helps simplify an assembly process.

In the embodiments, because the microphone 3, the first bracket 1, the first speaker 2, and the like may be first assembled to form an independent module (the audio assembly 20), when the module is assembled into the housing 10, there is substantially no need to consider impact of another component (for example, the housing 10) of the earphone 100 on the microphone 3, the first bracket 1, and the first speaker 2. This helps improve accuracy and consistency in mounting the module (the audio assembly 20) in the housing 10.

In some embodiments, as described above, the first surface 1c is formed on a side of the top portion 1a, the second surface 1d is formed on another side of the top portion 1a, and the first surface 1c is parallel to the second surface 1d. In this case, the microphone 3 and the first speaker 2 are connected to surfaces on the two sides of the top portion 1a respectively, and there is substantially no spacing between the microphone 3, the top portion 1a, and the first speaker 2 in the first direction, so that the audio assembly 20 has high compactness and a small size in the first direction.

In some embodiments, when the audio assembly 20 further includes the second speaker 5, the second speaker 5 may also propagate a sound to the outside of the earphone 100 through the sound outlet channel 105. Because the second speaker 5 is fastened to the first bracket 1 and the first bracket 1 is fastened to the housing 10, the second speaker 5 may be fastened to the housing 10 through the first bracket 1. The first bracket 1, the first speaker 2, and the second speaker 5 are sequentially stacked in the first direction.

In this case, the second speaker 5 can also be stacked in the first direction, with no need for an additional fastening component and a space to be occupied by the another fastening component. This helps improve compactness of the audio assembly 20. In addition, because the second speaker 5 is also stacked in the first direction, the second speaker 5 may be positioned and fastened in the first direction during mounting, which is the same as a direction in which the first speaker 2 is positioned and fastened during mounting. This reduces complexity in mounting the second speaker 5, to reduce complexity in assembling the audio assembly 20.

In some embodiments, as described above, the second speaker 5 is mounted on the end portion of the first bracket 1, the first bracket 1 and the second speaker 5 enclose the mounting space, and the first speaker 2 is located in the mounting space. In this case, the first bracket 1 covers the first speaker 2, the first speaker 2 and the first bracket 1 reuse a space in the first direction, and the first bracket 1 can be directly connected to the second speaker 5. In this way, structures of the first bracket 1, the first speaker 2, and the second speaker 5 can be more compact, and space utilization is higher, to help improve miniaturization of the audio assembly 20. In addition, this facilitates fastening of the first speaker 2 and the second speaker 5 to the first bracket 1.

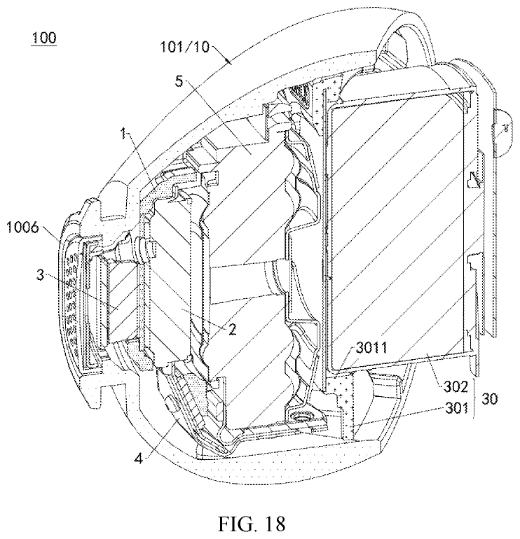

Refer to FIG. 3 and FIG. 18. FIG. 18 is a sectional view of a partial structure of the earphone 100 shown in FIG. 1 in some other embodiments.

In some embodiments, the battery assembly 30 includes a second bracket 301 and a battery 302. The second bracket 301 is fastened to the battery 302.

For example, the second bracket 301 may be an integrally formed mechanical part. The second bracket 301 may be provided with a fastening groove 3011.

For example, the battery 302 can store power, and the battery 302 is configured to supply power to an energy-consuming component in the earphone 100. Energy-consuming components in the earphone 100 are not enumerated herein. The battery 302 may be approximately of a cylindrical structure, to match a shape of the earphone 100. The battery 302 may be mounted in the fastening groove 3011 in a fixed manner.

In some embodiments, the second bracket 301 and the battery 302 of the battery assembly 30 may be located in the accommodation space 104 of the housing 10.

For example, the first bracket 1, the second bracket 301, and the battery 302 are arranged in the first direction, and the second bracket 301 is located on a side that is of the first bracket 1 and that faces away from the microphone 3. For example, when the earphone 100 includes the second speaker 5, the second speaker 5, the second bracket 301, and the battery 302 may be sequentially arranged. In some examples, the second bracket 301 and the battery 302 may be sequentially assembled into the housing 10. In some other examples, the second bracket 301 and the battery 302 may alternatively be assembled to form the battery assembly 30, and then assembled into the housing 10. Assembly of the second bracket 301 and the battery 302 is not strictly limited in the examples.

In the embodiments, the second bracket 301 and the battery 302 may be assembled into the accommodation space 104 of the housing 10 in the first direction. This facilitates consistency with a direction in which the audio assembly 20 is assembled, reduces assembly complexity, and simplifies a step of assembling the earphone 100, to improve efficiency and quality in assembling the earphone 100.

In the embodiments, after the first housing 101 and the second housing 102 are aligned with and fastened to each other to form the housing 10, the microphone 3, the first bracket 1, the first speaker 2, and the second speaker 5 of the audio assembly 20 are all located in a mounting space of the housing 10, and the housing 10 supports and protects the foregoing components.

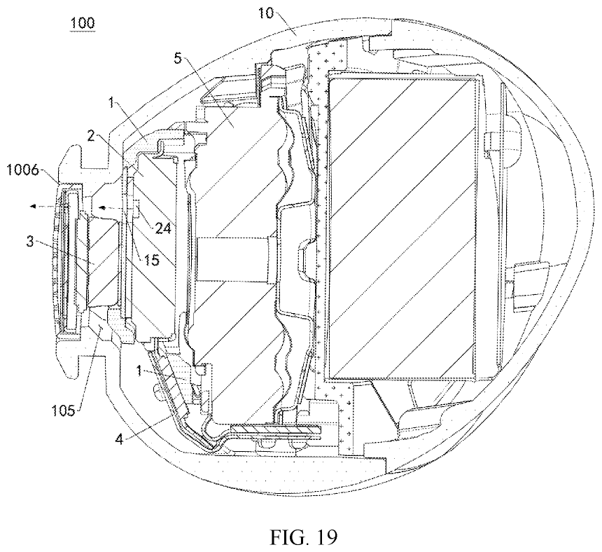

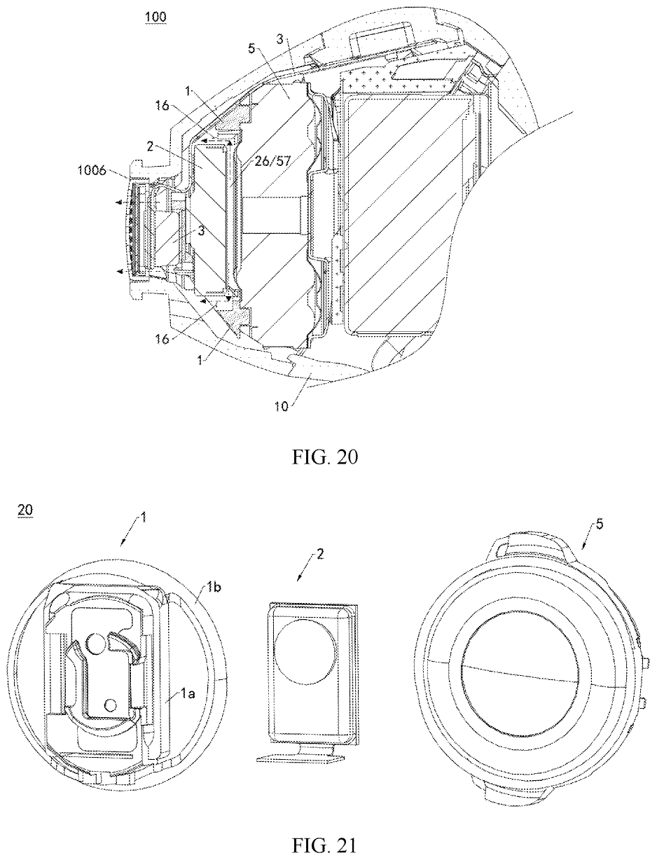

Refer to FIG. 19 and FIG. 20. FIG. 19 is a sectional view of the earphone 100 shown in FIG. 1 in some embodiments. FIG. 20 is a sectional view of the earphone 100 shown in FIG. 1 from another viewpoint. Both a sectional plane in FIG. 19 and a sectional plane in FIG. 20 are parallel to the central axis 1004, and the sectional plane in FIG. 19 and the sectional plane in FIG. 20 are perpendicular to each other.

In some embodiments, in the earphone 100, for the first speaker 2, the sound-emitting opening 24 of the first speaker 2 is connected to the first through hole 15 (as shown in FIG. 7). In this case, as shown by dashed arrows in FIG. 19, a sound emitted by the first speaker 2 may enter the sound outlet channel 105 from the sound-emitting opening 24 through the first through hole 15, and be propagated to the outside of the housing 10 from the sound outlet channel 105 through the sound outlet opening 1006.

In some embodiments, for the second speaker 5, the first speaker 2 is spaced from the second speaker 5, a space between the first speaker 2 and the second speaker 5 forms a rear cavity 26 of the first speaker 2 and forms a front cavity 57 of the second speaker 5, and the second through hole 16 (as shown in FIG. 7) connects the front cavity 57 of the second speaker 5 to the sound outlet channel 105. In this case, as shown by dashed arrows in FIG. 19, the front cavity 57 of the second speaker 5 communicates with the second through hole 16, the second speaker 5 is equivalent to outputting a sound through the second through hole 16, and the sound of the second speaker 5 is propagated to the second through hole 16 from the front cavity 57, enters the sound outlet channel 105 from the second through hole 16, and is propagated to the outside of the housing 10. The second through hole 16 is provided on the first bracket 1, and it is easy to set an area of the second through hole 16 to be large, so that the second speaker 5 has a large sound outlet area. In addition, both the sound of the first speaker 2 and the second speaker 5 are fastened to the first bracket 1, and sounds of both the first speaker 2 and the second speaker 5 enter the sound outlet channel 105 through the first bracket 1. This helps simplify a design of sound channels of the first speaker 2 and the second speaker 5 in the earphone 100.

It may be understood that, the rear cavity of the second speaker 5 may communicate with the vent hole 103 on the housing 10, and a specific communication structure is not strictly limited in the embodiments.

FIG. 21 is a diagram of an exploded structure of a partial structure of the audio assembly 20 shown in FIG. 3 in some other embodiments.

In some embodiments, a difference between the audio assembly 20 shown in FIG. 21 and the audio assembly 20 shown in FIG. 6 mainly lies in structures of a first bracket 1, a first speaker 2, and a second speaker 5.

For example, the first bracket 1 may include a top portion 1a and a side portion 1b, and the side portion 1b is disposed around the top portion 1a. The top portion 1a may be approximately of a rectangular structure, and a main portion 111 may be approximately of a circular ring structure. For disposition of the structure of the first bracket 1, refer to related descriptions in the embodiments in FIG. 7 to FIG. 9. Details are not described again in the embodiments.

For example, the first speaker 2 may be approximately of a rectangular block structure. The first speaker 2 may be a MEMS (Micro Electro Mechanical System) speaker. A projection of the first speaker 2 in a first direction may be smaller than a projection of the top portion 1a in the first direction. For disposition of the structure of the first speaker 2, refer to related descriptions in the embodiments in FIG. 10. Details are not described again in the embodiments. A volume of the first speaker 2 is small, to facilitate a miniaturization design of the audio assembly 20.

For example, the second speaker 5 may be a moving-coil single-diaphragm speaker. The second speaker 5 may not be provided with a structure such as a positioning hole or a fastening hole.

In the embodiments, for a manner of assembling the first bracket 1, the first speaker 2, and the second speaker 5, refer to related solutions in the embodiments in FIG. 13. Details are not described again in the embodiments.

It should be noted that embodiments of this disclosure and features in embodiments may be combined with each other without a conflict, and any combination of features in different embodiments also falls within the protection scope of this disclosure. In other words, the plurality of embodiments described above may be further combined according to an actual requirement.

It should be noted that all the foregoing accompanying drawings are example figures of this disclosure, and do not represent actual sizes of products. In addition, a size proportional relationship between components in the accompanying drawings is not intended to limit an actual product in this disclosure.

The foregoing descriptions are merely some embodiments and implementations of this disclosure, but are not intended to limit the protection scope of this disclosure. Any variation or replacement readily figured out by a person skilled in the art within the technical scope disclosed in this disclosure shall fall within the protection scope of this disclosure. Therefore, the protection scope of this disclosure shall be subject to the protection scope of the claims.

What is claimed is:

1. A sound output apparatus, comprising:
a housing comprising an outside and an accommodation space;
a microphone;
a first speaker; and
a first bracket fastened within the accommodation space and comprising:
a first surface fastening the microphone;
a second surface facing away from the first surface and fastening the first speaker;
a first mounting groove comprising a first bottom surface, wherein the first surface is at least partially formed on the first bottom surface, and wherein the microphone is at least partially disposed in the first mounting groove; and
a second mounting groove comprising a second bottom surface, wherein the second surface is at least partially formed on the second bottom surface, and wherein the first speaker is at least partially disposed in the second mounting groove.

2. The sound output apparatus of claim 1, wherein the first bracket further comprises a positioning groove, wherein the first speaker comprises a positioning portion that protrudes radially outward from the first speaker, and wherein the positioning portion is disposed in the positioning groove and is fastened to a groove wall of the positioning groove.

3. The sound output apparatus of claim 2, further comprising a second speaker fastened to the first bracket, wherein the first bracket, the first speaker, and the second speaker are sequentially stacked in a direction in which the microphone, the first bracket, and the first speaker are arranged, wherein the second speaker is mounted on an end portion of the first bracket, and wherein the first bracket and the second speaker enclose a mounting space in which the first speaker is disposed.

4. The sound output apparatus of claim 2, wherein the housing comprises a sound outlet opening, wherein the first bracket and the housing enclose a sound outlet channel, wherein the sound outlet opening connects the sound outlet channel to the outside, wherein the sound output apparatus further comprises a second speaker fastened to the first bracket, wherein the first bracket comprises a second through hole, wherein the first speaker is spaced from the second speaker, wherein a space between the first speaker and the second speaker forms a rear cavity of the first speaker and a front cavity of the second speaker, and wherein the second through hole connects the front cavity to the sound outlet channel.

5. The sound output apparatus of claim 2, further comprising:
a flexible circuit board, wherein the flexible circuit board and the microphone are an integrally formed mechanical part; and
a second speaker fastened to the first bracket and the flexible circuit board, and
wherein the flexible circuit board is electrically connected to the first speaker and the second speaker.

6. The sound output apparatus of claim 1, wherein the first bracket further comprises:
a top portion comprising:
a first side disposing the first surface; and
a second side disposing the second surface; and
a side portion surrounding the top portion and extending in a direction away from the first surface,
wherein the first surface is parallel to the second surface.

7. The sound output apparatus of claim 1, wherein the first bracket comprises:
a main portion comprising plastic; and
a fastened portion that comprises a first side and a second side, is a metal sheet, and is embedded in the main portion between the first speaker and the microphone,
wherein the first surface is defined by the first side of the fastened portion, and
wherein the second surface is defined by the second side.

8. The sound output apparatus of claim 1, further comprising a sound outlet channel enclosed by the first bracket and the housing, wherein the housing further comprises a sound outlet opening connecting the sound outlet channel to an outside of the housing, and wherein the microphone is disposed in the sound outlet channel on a side of the first bracket that faces the sound outlet opening.

9. The sound output apparatus of claim 8, wherein the first surface faces the sound outlet opening, wherein the first bracket further comprises a first through hole, wherein the first speaker comprises a sound-emitting opening, and wherein the first through hole connects the sound-emitting opening to the sound outlet channel.

10. The sound output apparatus of claim 8, wherein the first bracket comprises a fastened surface that is fastened to the housing, and wherein the fastened surface is a flat surface that is perpendicular to a central axis of the sound outlet opening.

11. The sound output apparatus of claim 1, further comprising a second speaker fastened to the first bracket, and wherein the first bracket, the first speaker, and the second speaker are sequentially stacked in a first direction.

12. The sound output apparatus of claim 11, wherein the first bracket further comprises an end portion mounting the second speaker.

13. The sound output apparatus of claim 11, wherein the first bracket further comprises a positioning pillar and a fastening pillar, wherein an end portion of the second speaker that faces the first bracket comprises a positioning hole and a fastening hole, wherein the positioning pillar is in a clearance fit with the positioning hole, wherein the fastening pillar is disposed in the fastening hole, and wherein the fastening pillar is bonded to the fastening hole by an adhesive.

14. The sound output apparatus of claim 11, further comprising a sound outlet channel enclosed by the first bracket and the housing, wherein a sound outlet opening of the housing connects the sound outlet channel to the outside, wherein the first bracket comprises a second through hole, wherein a space between the first speaker and the second speaker defines a rear cavity of the first speaker and a front cavity of the second speaker, and wherein the second through hole connects the front cavity to the sound outlet channel.

15. The sound output apparatus of claim 11, wherein the second speaker comprises a first sub-speaker and a second sub-speaker arranged in the first direction, wherein the first sub-speaker faces the first speaker, and wherein the second sub-speaker faces in a second direction away from the first speaker relative to the first sub-speaker.

16. The sound output apparatus of claim 11, wherein the second speaker comprises a first sub-speaker and a second sub-speaker, and wherein the first sub-speaker is fastened to the second sub-speaker.

17. The sound output apparatus of claim 16, wherein the sound output apparatus further comprises a flexible circuit board that is integral with the microphone and is electrically connected to the first speaker and the second speaker.

18. The sound output apparatus of claim 17, wherein the flexible circuit board is disposed outside the microphone, the first bracket, the first speaker, and the second speaker, wherein the first speaker comprises a first wiring portion, wherein the first bracket comprises a third through hole, wherein the first wiring portion passes through the third through hole, and wherein the first wiring portion is electrically connected to the flexible circuit board.

19. The sound output apparatus of claim 1, further comprising:
a battery; and
a second bracket fastened to the battery and to the housing,
wherein the second bracket and the battery are disposed in the accommodation space,
wherein the second bracket is disposed on a side of the first bracket facing away from the microphone, and
wherein the first bracket, the second bracket, and the battery are arranged in a direction, in which the microphone, the first bracket, and the first speaker are arranged.

20. A sound output apparatus, comprising:
a housing comprising an accommodation space;
a first bracket in the accommodation space, wherein the first bracket is a cover structure comprising:
a cover space;
an end portion;
a top portion comprising a first side and a second side;
a side portion surrounding the top portion;
a first surface formed on the first side; and
a second surface formed on the second side and facing away from the first surface;
a microphone fastened to the first surface;
a first speaker fastened to the second surface and disposed in the cover space; and
a second speaker mounted on the end portion,
wherein the first bracket and the second speaker enclose a mounting space in which the first speaker is disposed, and
wherein the first bracket, the first speaker, and the second speaker are sequentially stacked in a direction in which the microphone, the first bracket, and the first speaker are arranged.
